(19) United States
(12) Patent Application Publication
(10) Pub. No.: US 2014/0061969 A1
(43) Pub. Date: Mar. 6, 2014

(54) PATTERNING METHOD AND TEMPLATE

(71) Applicants: Yosuke OKAMOTO, Mie-ken (JP); Kazuo Tawarayama, Mie-ken (JP); Nobuhiro Komine, Mie-ken (JP)

(72) Inventors: Yosuke OKAMOTO, Mie-ken (JP); Kazuo Tawarayama, Mie-ken (JP); Nobuhiro Komine, Mie-ken (JP)

(21) Appl. No.: 13/721,631

(22) Filed: Dec. 20, 2012

(30) Foreign Application Priority Data
Aug. 31, 2012 (JP) 2012-192568

(51) Int. Cl. B29C 59/00

(52) U.S. Cl. CPC B29C 59/002
USPC 264/293; 425/385

(57) ABSTRACT

According to one embodiment, a patterning method includes releasing the template from the cured imprint resist, aligning an alignment mark formed in the non-imprint portion of the template with the transfer pattern of the alignment pattern without causing the alignment mark to contact the imprint resist, and causing the main pattern and the alignment pattern of the template to contact an imprint resist that is supplied to a shot region adjacent to the cured imprint resist and uncured. The method includes curing the imprint resist of the adjacent shot region in the state of the template being in contact to form the transfer pattern of the main pattern and the transfer pattern of the alignment pattern in the imprint resist.

### CROSS-REFERENCE TO RELATED APPLICATION

This application is based upon and claims the benefit of priority from Japanese Patent Application No. 2012-192568, filed on Aug. 31, 2012; the entire contents of which are incorporated herein by reference.

### FIELD

Embodiments described herein relate generally to a patterning method and a template.

### BACKGROUND

Pattern transfer technology by imprinting is drawing attention as technology in the manufacturing processes of semiconductor devices to form fine patterns while being suitable for mass production. In imprinting, an imprint resist such as a liquid organic material, etc., is supplied onto a wafer; and the imprint resist is cured by, for example, light irradiation in the state in which a template including an unevenness pattern is caused to contact the imprint resist.

Although a method for aligning the template with the wafer has been proposed in which mark groups are pre-formed in the wafer and the pattern is transferred onto multiple shot regions while aligning the template with the mark groups, forming the mark groups to be aligned with the wafer with high precision leads to higher costs.

### BRIEF DESCRIPTION OF THE DRAWINGS

FIG. 1A is a schematic perspective view of a template of an embodiment, FIG. 1B is a schematic cross-sectional view of a portion of the template of the embodiment;

FIGS. 2A to 2D are schematic cross section views showing a patterning method of the embodiment;

FIG. 3 is a schematic view showing the patterning method of the embodiment;

FIGS. 4A and 4B are schematic plan views showing the patterning method of the embodiment;

FIGS. 5A to 5D are schematic cross section views showing the patterning method of the embodiment; and

FIGS. 6A and 6B are schematic plan views of another example of combination of an alignment mark and an alignment pattern (a transfer pattern of an alignment pattern).

### DETAILED DESCRIPTION

According to one embodiment, a patterning method includes causing a main pattern and an alignment pattern of a template to contact an imprint resist that is supplied onto a patterning body and uncured. The template has a mesa portion and a non-imprint portion provided to recede from the mesa portion in a region on an outer side of the mesa portion. The main pattern and the alignment pattern are formed as unevenness patterns in the mesa portion. The method includes curing the imprint resist in the state of the template being in contact to form a transfer pattern of the main pattern and a transfer pattern of the alignment pattern in the imprint resist. The method includes releasing the template from the cured imprint resist, aligning an alignment mark formed in the non-imprint portion of the template with the transfer pattern of the alignment pattern without causing the alignment mark to contact the imprint resist, and causing the main pattern and the alignment pattern of the template to contact an imprint resist that is supplied to a shot region adjacent to the cured imprint resist and uncured. The method includes curing the imprint resist of the adjacent shot region in the state of the template being in contact to form the transfer pattern of the main pattern and the transfer pattern of the alignment pattern in the imprint resist.

Embodiments will now be described with reference to the drawings. Similar components in the drawings are marked with like reference numerals.

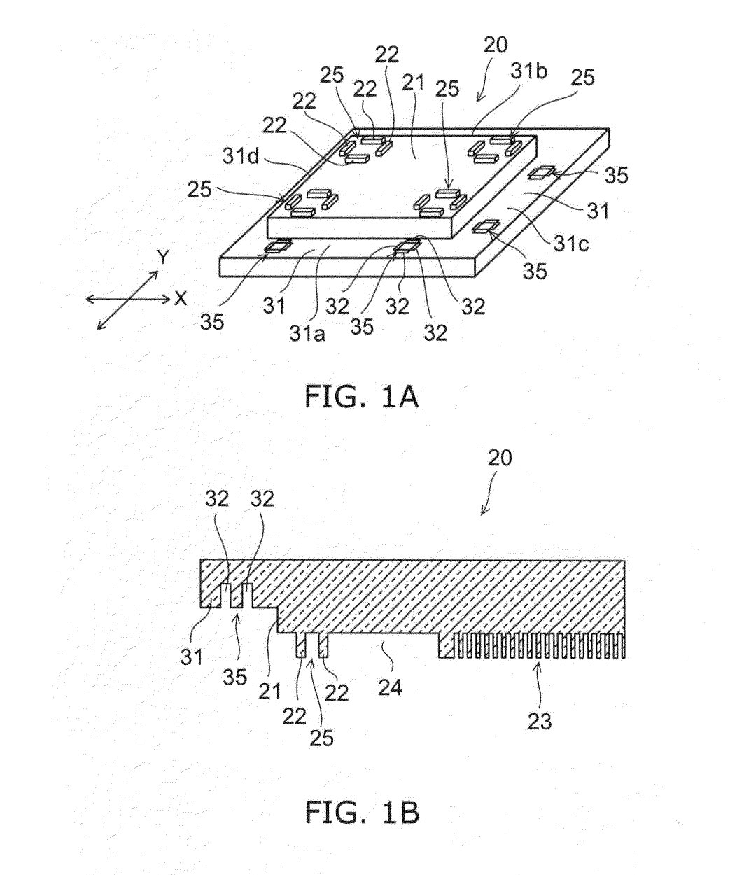

FIG. 1A is a schematic perspective view of a template 20 of an embodiment; and FIG. 1B is a schematic cross-sectional view of a portion of the template 20 of the embodiment.

For the template 20 shown in FIG. 1A, the surface where an unevenness pattern is formed faces upward; and for the template 20 shown in FIG. 1B, the surface where the unevenness pattern is formed faces downward.

FIG. 1B shows the cross section of the template 20 on an end portion side where alignment marks 35 and alignment patterns 25 are formed.

In FIG. 1A, among the unevenness patterns formed in the template 20, a main pattern 23 that is used as a circuit pattern of a semiconductor device is not shown; and only the alignment patterns 25 and the alignment marks 35 are shown.

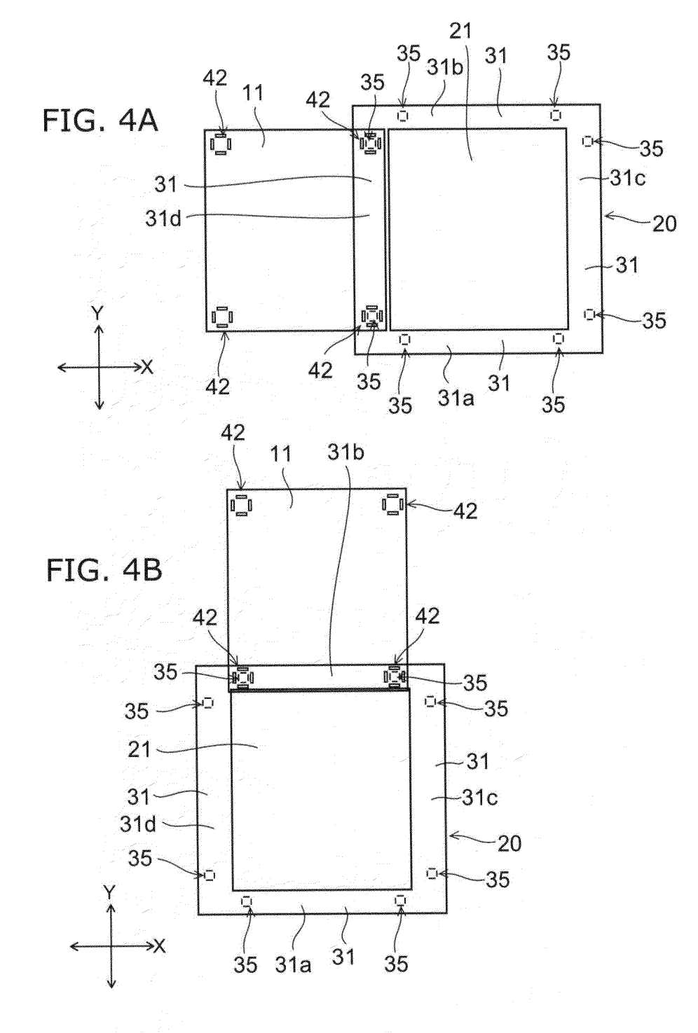

FIGS. 4A and 4B are schematic plan views of the template 20. Only the alignment marks 35 of the template 20 are shown in FIGS. 4A and 4B.

The template 20 is formed in, for example, a plate configuration having a quadrilateral exterior configuration; and a mesa portion 21 is provided on one surface side. The planar configuration of the mesa portion 21 is a quadrilateral configuration; and a non-imprint portion 31 is provided in a region around the mesa portion 21. The mesa portion 21 protrudes from the non-imprint portion 31; and conversely, the non-imprint portion 31 recedes from the mesa portion 21.

The mesa portion 21 is provided in the region on the inner side of the template 20 including the surface-direction center; and the non-imprint portion 31 is provided in the region on the outer side of the mesa portion 21 in the surface direction. When the template 20 is viewed in plan from the side of the surface where the mesa portion 21 is provided, the non-imprint portion 31 is provided continuously around the mesa portion 21.

The template 20 is made of a material (e.g., quartz) that is transmissive to light (e.g., ultraviolet light) that cures an imprint resist 11 described below. The mesa portion 21 and the non-imprint portion 31 are provided as a single body.

The main pattern 23 and the alignment patterns 25 are formed at the front surface of the mesa portion 21. Both the main pattern 23 and the alignment patterns 25 are formed as unevenness patterns.

As shown in FIG. 1A, one alignment pattern 25 includes, for example, four protrusions 22 having bar configurations that are combined in a quadrilateral configuration; and the alignment patterns 25 are formed at the front surface of the mesa portion 21 proximal to the four corners.

The main pattern 23 is formed in the region on the inner side of the four alignment patterns 25. The main pattern 23 is a pattern corresponding to the circuit pattern of the semiconductor device and has multiple recesses and multiple protrusions that are repeated at a fine pitch corresponding to the circuit pattern.

The alignment marks 35 are formed as unevenness patterns in the non-imprint portion 31. The protrusions of the unevenness patterns included in the alignment marks 35 do not protrude higher than the mesa portion 21.

Multiple alignment marks 35 are formed in the non-imprint portion 31; and one alignment mark 35 has, for example, four recesses 32 having bar configurations combined in a quadrilateral configuration.

The alignment patterns 25 are formed in the end portion region of the mesa portion 21 between the main pattern 23 and the alignment marks 35.

Here, two orthogonal directions in a plane parallel to the front surface of the mesa portion 21 are taken as an X direction (a first direction) and a Y direction (a second direction).

For the front surface of the mesa portion 21 as shown in FIG. 1A, two alignment patterns 25 are arranged in the X direction in a region on one end side in the Y direction; and two alignment patterns 25 also are arranged in the X direction in a region on the other end side in the Y direction.

Also, for the front surface of the mesa portion 21, two alignment patterns 25 are arranged in the Y direction in a region on one end side in the X direction; and two alignment patterns 25 also are arranged in the Y direction in a region on the other end side in the X direction.

As shown in FIGS. 1A and FIGS. 4A and 4B, the non-imprint portion 31 includes a pair of regions 31a and 31b extending in the X direction with the mesa portion 21 interposed in the Y direction, and a pair of regions 31c and 31d extending in the Y direction with the mesa portion 21 interposed in the X direction.

In each of the region 31a and the region 31b, two alignment marks 35 are arranged at a pitch corresponding to the pitch of the alignment patterns 25 in the X direction.

In each of the region 31c and the region 31d, two alignment marks 35 are arranged at a pitch corresponding to the pitch of the alignment patterns 25 in the Y direction.

Accordingly, eight alignment marks 35 are formed in the non-imprint portion 31. Each of the alignment marks 35 is formed proximally to a corner of the mesa portion 21.

One alignment mark 35 and one alignment pattern 25 are used to form a bar-in-bar combination. As described below with reference to FIGS. 4A and 4B, when the alignment mark 35 is overlaid on a transfer pattern (an alignment transfer pattern) 42 of the alignment pattern 25 formed in the imprint resist 11, for example, the quadrilateral formed of the alignment mark 35 can be contained inside the quadrilateral formed of the alignment transfer pattern 42.

Because the pitch of the alignment marks 35 in the Y direction corresponds to the pitch of the alignment patterns 25 in the Y direction, it is possible for two alignment marks 35 arranged in the Y direction to be contained simultaneously inside the alignment transfer patterns 42 as shown in FIG. 4A.

Also, because the pitch of the alignment marks 35 in the X direction corresponds to the pitch of the alignment patterns 25 in the X direction, it is possible for two alignment marks 35 arranged in the X direction to be contained simultaneously inside the alignment transfer patterns 42 as shown in FIG. 4B.

The pitch of the unevenness of the alignment pattern 25 and the pitch of the unevenness of the alignment mark 35 are larger than the minimum pitch of the unevenness of the main pattern 23. Therefore, the transfer patterns (the alignment transfer patterns) 42 of the alignment patterns 25 and the alignment marks 35 overlaid on the alignment transfer patterns 42 can be easily detected optically using a camera, etc.

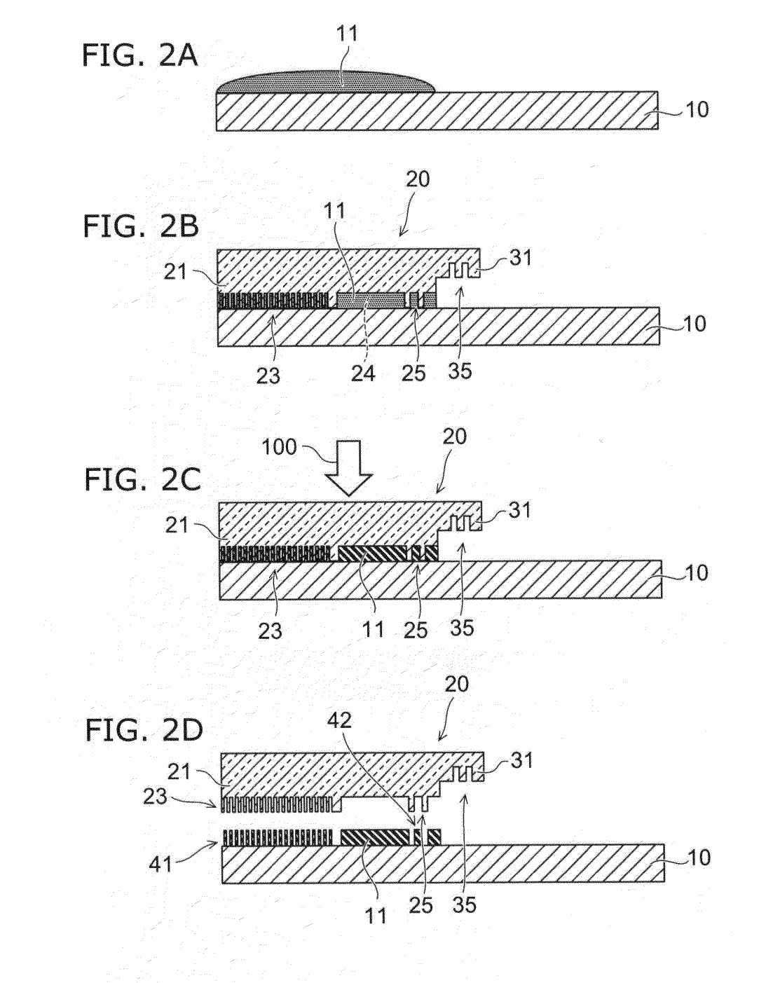

The patterning method according to the first embodiment will now be described with reference to FIG. 2A to FIG. 5D.

As shown in FIG. 2A, the uncured imprint resist 11 is supplied as a liquid onto a wafer 10 as the patterning body. The imprint resist 11 is, for example, a resin that is cured by ultraviolet light.

The imprint resist 11 is supplied to each region (shot region) that is multiply divided in the surface of the wafer 10. Then, as described below, the imprint resist 11 is cured in the state in which the template 20 is caused to contact the uncured imprint resist 11 to transfer the main pattern 23 and the alignment patterns 25 formed in the template 20 onto the imprint resist 11.

When the imprint for one shot region ends, the uncured imprint resist 11 is newly supplied to one other shot region adjacent to the one shot region; the template 20 is caused to contact the imprint resist 11; and the imprint resist 11 is cured. Then, the uncured imprint resist 11 is further supplied to a shot region adjacent to the one other shot region; and the procedure is repeated. In other words, the pattern of the template 20 is transferred onto multiple shot regions of the front surface of the wafer 10 by a step-and-repeat method.

After the imprint resist 11 is supplied to one shot region, the main pattern 23 and the alignment patterns 25 formed in the mesa portion 21 of the template 20 are caused to contact the uncured imprint resist 11 as shown in FIG. 2B.

The uncured imprint resist 11 is filled into the recesses of the main pattern 23, the recesses of the alignment patterns 25, and a recess 24 between the main pattern 23 and the alignment patterns 25.

At this time, the non-imprint portion 31 which is provided to recede from the mesa portion 21 does not contact the imprint resist 11.

Then, the imprint resist 11 is cured in the state shown in FIG. 2B in which the template 20 contacts the imprint resist 11. Specifically, as shown in FIG. 2C, the imprint resist 11 is cured by irradiating ultraviolet light 100 through the template 20 onto the imprint resist 11 from above the template 20.

Or, a thermosetting resin may be used as the imprint resist 11; and the imprint resist 11 may be cured by heating. In such a case, the template 20 may not be light-transmissive.

After the imprint resist 11 is cured, the template 20 is released from the imprint resist 11 as shown in FIG. 2D.

A main transfer pattern 41 where the unevenness of the main pattern 23 of the template 20 is inverted and the alignment transfer patterns 42 where the unevenness of the alignment patterns 25 of the template 20 is inverted are formed in the cured imprint resist 11. The alignment transfer patterns 42 are formed in the end portion region of the shot region.

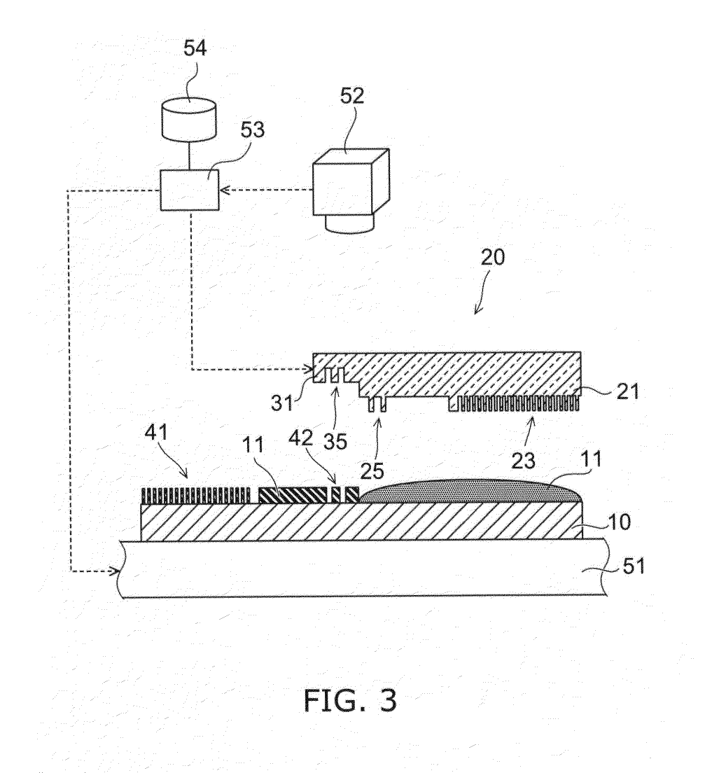

Then, as shown in FIG. 3, the uncured imprint resist 11 is supplied to a shot region adjacent to the imprinted shot region having the imprint resist 11 where the main transfer pattern 41 and the alignment transfer patterns 42 already are formed. Further, the template 20 is moved onto the adjacent shot region.

Then, the alignment marks 35 formed in the non-imprint portion 31 of the template 20 are overlaid on the imprinted alignment transfer patterns 42 formed in the end portion region of the adjacent shot region above the alignment transfer patterns 42 in non-contact with the alignment transfer patterns 42.

A camera 52 is provided above the template 20; and the positions of the alignment marks 35 and the positions of the alignment transfer patterns 42 are optically detected by the camera 52.

A detection signal is sent to a controller 53; and the controller 53 corrects the relative positions of the wafer 10 and the template 20 by moving one or both of a stage 51 that supports the wafer 10 and the template 20 if necessary based on the detection signal. The template 20 and the wafer 10 are moved relatively in the X direction or the Y direction shown in FIGS. 4A and 4B and are moved relatively in a direction of rotation inside the XY plane.

In the case where the imprinted shot region and the next shot region to be imprinted are adjacent in the X direction as shown in FIG. 4A, the alignment marks 35 are aligned with the alignment transfer patterns 42 such that two alignment marks 35 arranged in the Y direction in the non-imprint portion 31 of the template 20 are contained respectively on the inner sides of two alignment transfer patterns 42 already formed in the end portion region of the imprint resist 11 and arranged in the Y direction.

Or, in the case where the imprinted shot region and the next shot region to be imprinted are adjacent in the Y direction as shown in FIG. 4B, the alignment marks 35 are aligned with the alignment transfer patterns 42 such that two alignment marks 35 arranged in the X direction in the non-imprint portion 31 of the template 20 are contained respectively on the inner sides of two alignment transfer patterns 42 already formed in the end portion region of the imprint resist 11 and arranged in the X direction.

In the case where the shot region to be imprinted is respectively adjacent in the X direction and the Y direction to two previously-imprinted shot regions, the alignment marks 35 are aligned with the alignment transfer patterns 42 between the shot region to be imprinted and the imprinted shot region adjacent in the X direction such that two alignment marks 35 arranged in the Y direction in the non-imprint portion 31 of the template 20 are contained respectively on the inner sides of two alignment transfer patterns 42 already formed in the end portion region of the imprint resist 11 and arranged in the Y direction. And the alignment marks 35 are aligned with the alignment transfer patterns 42 between the shot region to be imprinted and the imprinted shot region adjacent in the Y direction such that two alignment marks 35 arranged in the X direction in the non-imprint portion 31 of the template 20 are contained respectively on the inner sides of two alignment transfer patterns 42 already formed in the end portion region of the imprint resist 11 and arranged in the X direction.

The template 20 is aligned with the imprinted shot region by the alignment marks 35 of the template 20 being aligned with the alignment transfer patterns 42 formed in the imprinted shot region. The imprint resist 11 of the adjacent shot region is patterned using the template 20. As a result, two main transfer patterns 41 transferred respectively onto two adjacent shot regions using the template 20 have an orderly arrangement at the desired distance (pitch).

Further, because multiple pairs (in the embodiment, two pairs) of the combined pair of the overlaid alignment mark 35 and alignment transfer pattern 42 are arranged in each of the X direction and the Y direction, the tilt (the rotation) in the XY plane of the template 20 with respect to the shot regions also can be corrected.

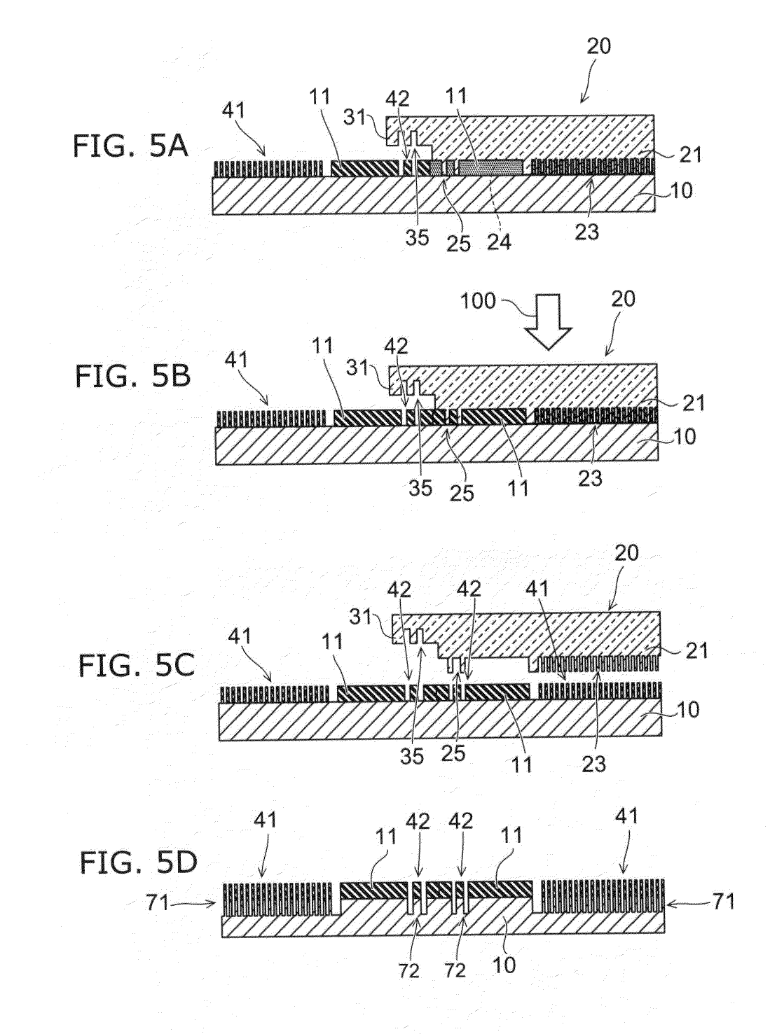

Then, the alignment marks 35 are overlaid on the alignment transfer patterns 42; the state in which the template 20 is aligned with the wafer 10 is maintained; and the main pattern 23 and the alignment patterns 25 formed in the mesa portion 21 of the template 20 are caused to contact the uncured imprint resist 11 supplied to the shot region now being imprinted as shown in FIG. 5A.

At this time as well, the non-imprint portion 31 provided to recede from the mesa portion 21 does not contact the imprint resist 11. The mesa portion 21 formed in the region on the inner side of the non-imprint portion 31 in the surface direction of the template 20 does not overlap the cured imprint resist 11 of the adjacent imprinted shot region.

Accordingly, the template 20 does not physically interfere with the main transfer pattern 41 and the alignment transfer patterns 42 already formed in the imprint resist 11 of the imprinted shot region when imprinting one other adjacent shot region.

In the template 20, the alignment patterns 25 are formed in the end portion region of the mesa portion 21 between the main pattern 23 and the alignment marks 35. Therefore, the transfer patterns (the alignment transfer patterns) 42 of the alignment patterns 25 are formed in the end portion region of the shot region. Accordingly, the alignment marks 35 formed in the non-imprint portion 31 can be overlaid on the alignment transfer patterns 42 while suppressing the increase of the protruding width of the non-imprint portion 31 in the surface direction.

As shown in FIG. 5A, the uncured imprint resist 11 is filled into the recesses of the main pattern 23, the recesses of the alignment patterns 25, and the recess 24 between the main pattern 23 and the alignment patterns 25 of the template 20.

Then, in the state in which the template 20 contacts the imprint resist 11, the imprint resist 11 is cured by irradiating the ultraviolet light 100 through the template 20 onto the imprint resist 11 from above the template 20 as shown in FIG. 5B.

After the imprint resist 11 is cured, the template 20 is released from the imprint resist 11 as shown in FIG. 5C. The main transfer pattern 41 where the unevenness of the main pattern 23 of the template 20 is inverted and the alignment transfer patterns 42 where the unevenness of the alignment patterns 25 of the template 20 is inverted are formed in the cured imprint resist 11.

Then, the imprint resist 11, onto which the transfer pattern (the main transfer pattern) 41 of the main pattern 23 and the transfer patterns (the alignment transfer patterns) 42 of the alignment patterns 25 of the template 20 are transfer-formed, is formed in all of the shot regions by repeating the processes described above for each of the shot regions.

Subsequently, unevenness patterns 71 and 72 are formed at the front surface of the wafer 10 by performing etching of the wafer 10 as shown in FIG. 5D using the imprint resist 11 as a mask. Ultimately, the imprint resist 11 is removed from the wafer 10.

The unevenness pattern 71 formed under the main transfer pattern 41 of the imprint resist 11 corresponds to the circuit pattern of the semiconductor device and includes an unevenness that is repeated at a fine pitch.

The unevenness patterns 72 formed under the alignment transfer patterns 42 of the imprint resist 11 are formed in a region corresponding to the dicing region and do not remain in the semiconductor chip singulated by dicing. Or, the unevenness patterns 72 remain in the semiconductor chip after the singulation but do not function as circuits.

According to the embodiment described above, the transfer pattern (the main transfer pattern) 41 of the main pattern 23 formed in each of the multiple shot regions has an orderly arrangement at the desired spacing (pitch) by using the template 20 that has the mesa portion 21 including the alignment patterns 25 to be transferred with the main pattern 23 onto the imprint resist 11 and the non-imprint portion 31 including the alignment marks 35 that are aligned with the transfer patterns (the alignment transfer patterns) 42 of the alignment patterns 25 without pre-forming mark groups with high positional precision on the wafer 10. The cost can be reduced because it is unnecessary to form the mark groups that are aligned with the wafer 10 with high precision.

A patterning method according to a second embodiment will now be described.

In the second embodiment as well, the transfer patterns (the alignment transfer patterns) 42 of the alignment patterns 25 and the transfer pattern (the main transfer pattern) 41 of the main pattern 23 formed in the template 20 are formed in the imprint resist 11 by curing the imprint resist 11 in the state in which the template 20 is caused to contact the uncured imprint resist 11 supplied to each of the shot regions using a template 20 similar to that of the first embodiment.

In the first embodiment, the imprinting is repeated by aligning the alignment marks 35 of the template 20 with the alignment transfer patterns 42 formed in the imprint resist 11 of the adjacent imprinted shot region each time the imprinting of the shot region is performed.

Conversely, in the second embodiment, the imprinting is repeated by aligning the position of the template 20 with each of the shot regions of the wafer 10 front surface by a relative movement control between the wafer 10 and the template 20.

However, in the case where the imprinted alignment transfer patterns 42 already are formed adjacently to the shot region now being imprinted, the positions of the alignment transfer patterns 42 and the positions of the alignment marks 35 of the template 20 above the alignment transfer patterns 42 are detected by the camera 52 shown in FIG. 3.

From the detection result, the controller 53 shown in FIG. 3 calculates the alignment shift between the alignment marks 35 and the alignment transfer patterns 42 and calculates a correction parameter to correct the alignment shift (the distance between the adjacent shot region patterns) of the template 20 for the wafer 10. The correction parameter is stored in a memory device 54 shown in FIG. 3.

Then, when performing the imprinting of the next wafer 10 using the template 20, the controller 53 aligns the template 20 with each of the shot regions of the wafer 10 by controlling the relative movement between the stage 51 and the template 20 based on the correction parameter recited above that is read from the memory device 54.

By providing the correction data of the alignment between the wafer 10 and the template 20 obtained when imprinting the previous wafer 10 as feedback for the relative movement control of the template 20 for the next wafer 10, the multiple patterns can be transferred in an orderly arrangement with high precision.

According to the second embodiment, it is unnecessary to finely adjust the relative positions of the stage 51 and the template 20 for each shot such that the alignment marks 35 have the desired overlapping state with respect to the alignment transfer patterns 42; and the imprint processing can be performed with a high throughput.

The correction data recited above may be renewed for the imprint processing of each of the wafers 10; or the same correction data may be used for a number of multiple wafers 10 (e.g., the multiple wafers 10 of the same lot).

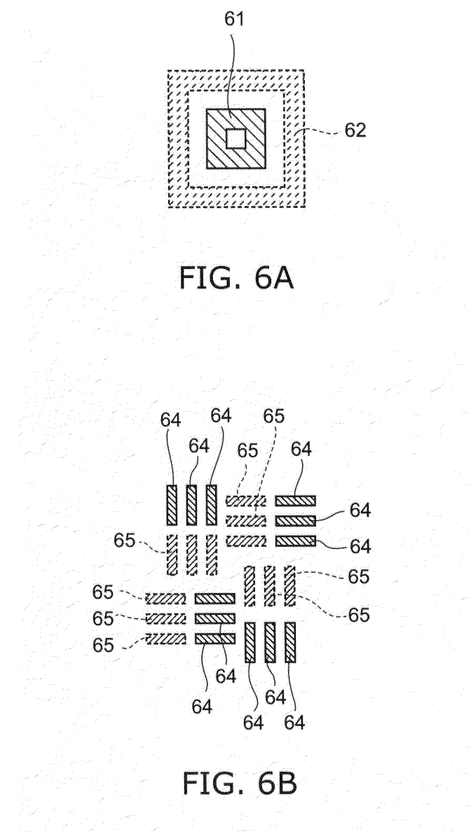

The combination of the alignment mark 35 and the alignment pattern 25 is not limited to the bar-in-bar type, and may be a box-in-box type as shown in FIG. 6A or a combination of line-and-space types as shown in FIG. 6B.

In the box-in-box type shown in FIG. 6A, both an alignment mark 61 and an alignment pattern are formed in quadrilateral box configurations; and in the example shown in FIG. 6A, the alignment mark 61 illustrated by the solid line is contained inside the transfer pattern (the alignment transfer pattern) 62 of the alignment pattern illustrated by the broken line to align the alignment mark 61 with the alignment transfer pattern 62.

For the line-and-space types shown in FIG. 6B, alignment marks 64 and alignment patterns have multiple line-and-space pattern groups. The line-and-space groups of the transfer patterns (the alignment transfer patterns) 65 of the alignment patterns illustrated by the broken lines and the line-and-space groups of the alignment marks 64 illustrated by the solid lines are combined and interposed between each other to align the alignment marks 64 with the alignment transfer patterns 65.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modification as would fall within the scope and spirit of the inventions.

What is claimed is:

1. A patterning method, comprising:
causing a main pattern and an alignment pattern of a template to contact an imprint resist that is supplied onto a patterning body and uncured, the template having a mesa portion and a non-imprint portion provided to recede from the mesa portion in a region on an outer side of the mesa portion, the main pattern and the alignment pattern being formed as unevenness patterns in the mesa portion;
curing the imprint resist in the state of the template being in contact to form a transfer pattern of the main pattern and a transfer pattern of the alignment pattern in the imprint resist;
releasing the template from the cured imprint resist, aligning an alignment mark formed in the non-imprint portion of the template with the transfer pattern of the alignment pattern without causing the alignment mark to contact the imprint resist, and causing the main pattern and the alignment pattern of the template to contact an imprint resist that is supplied to a shot region adjacent to the cured imprint resist and uncured; and
curing the imprint resist of the adjacent shot region in the state of the template being in contact to form the transfer pattern of the main pattern and the transfer pattern of the alignment pattern in the imprint resist.

2. The method according to claim 1, wherein the alignment pattern is formed in an end portion region of the mesa portion between the main pattern and the alignment mark.

3. The method according to claim 1, wherein an unevenness pitch of the alignment pattern is larger than a minimum unevenness pitch of the main pattern.

4. The method according to claim 1, wherein the alignment mark is aligned with the transfer pattern of the alignment pattern by overlaying the alignment mark on the transfer pattern of the alignment pattern above the transfer pattern of the alignment pattern and optically detecting a position of the alignment mark and a position of the transfer pattern of the alignment pattern.

5. The method according to claim 4, wherein the mesa portion does not overlap the previously-cured imprint resist in the state of the alignment mark overlaid on the transfer pattern of the alignment pattern above the transfer pattern of the alignment pattern.

6. The method according to claim 1, wherein
a plurality of the alignment patterns are arranged in a first direction, and
a plurality of the alignment marks are arranged in the first direction at a pitch corresponding to a pitch of the plurality of alignment patterns in the first direction.

7. The method according to claim 1, wherein
a plurality of the alignment patterns are arranged in a first direction and a second direction orthogonal to the first direction, and
a plurality of the alignment marks are arranged in the first direction at a pitch corresponding to a pitch of the plurality of alignment patterns in the first direction and arranged in the second direction at a pitch corresponding to a pitch of the plurality of alignment patterns in the second direction.

8. The method according to claim 1, wherein the alignment mark is formed as an unevenness pattern.

9. The method according to claim 1, wherein
the template is transmissive to light, and
the imprint resist is cured by irradiating the light through the template onto the imprint resist.

10. A patterning method, comprising:
aligning a patterning body and a template by a relative movement control of the patterning body and the template, and causing a main pattern and an alignment pattern of the template to contact an imprint resist that is supplied onto the patterning body and uncured, the template having a mesa portion and a non-imprint portion provided to recede from the mesa portion in a region on an outer side of the mesa portion, the main pattern and the alignment pattern being formed as unevenness patterns in the mesa portion;
curing the imprint resist in the state of the template being in contact to form a transfer pattern of the main pattern and a transfer pattern of the alignment pattern in the imprint resist;
releasing the template from the cured imprint resist, and performing a relative movement control of the patterning body and the template to cause the main pattern and the alignment pattern of the template to contact an imprint resist that is supplied to a shot region adjacent to the cured imprint resist and uncured while detecting an alignment shift between an alignment mark formed in the non-imprint portion of the template and the transfer pattern of the alignment pattern formed in the cured imprint resist, the alignment mark not contacting the imprint resist; and
curing the imprint resist of the adjacent shot region in the state of the template being in contact to form the transfer pattern of the main pattern and the transfer pattern of the alignment pattern in the imprint resist,
a relative movement between the template and another patterning body being controlled based on the detection result of the alignment shift between the alignment mark and the transfer pattern of the alignment pattern.

11. The method according to claim 10, wherein the alignment pattern is formed in an end portion region of the mesa portion between the main pattern and the alignment mark.

12. The method according to claim 10, wherein an unevenness pitch of the alignment pattern is larger than a minimum unevenness pitch of the main pattern.

13. The method according to claim 10, wherein the alignment shift between the alignment mark and the transfer pattern of the alignment pattern is detected by overlaying the alignment mark on the transfer pattern of the alignment pattern above the transfer pattern of the alignment pattern and optically detecting a position of the alignment mark and a position of the transfer pattern of the alignment pattern.

14. The method according to claim 13, wherein the mesa portion does not overlap the previously-cured imprint resist in the state of the alignment mark overlaid on the transfer pattern of the alignment pattern above the transfer pattern of the alignment pattern.

15. The method according to claim 10, wherein
a plurality of the alignment patterns are arranged in a first direction, and
a plurality of the alignment marks are arranged in the first direction at a pitch corresponding to a pitch of the plurality of alignment patterns in the first direction.

16. The method according to claim 10, wherein
a plurality of the alignment patterns are arranged in a first direction and a second direction orthogonal to the first direction, and
a plurality of the alignment marks are arranged in the first direction at a pitch corresponding to a pitch of the plurality of alignment patterns in the first direction and arranged in the second direction at a pitch corresponding to a pitch of the plurality of alignment patterns in the second direction.

17. The method according to claim 10, wherein the alignment mark is formed as an unevenness pattern.

18. The method according to claim 10, wherein
the template is transmissive to light, and
the imprint resist is cured by irradiating the light through the template onto the imprint resist.

19. A template, comprising:
a mesa portion including a main pattern and a plurality of alignment patterns, the main pattern being an unevenness pattern, the plurality of alignment patterns being unevenness patterns, the mesa portion being configured to contact an imprint resist; and
a non-imprint portion provided to recede from the mesa portion in a region on an outer side of the mesa portion and configured not to contact the imprint resist in a state of the mesa portion contacting the imprint resist, the non-imprint portion including a plurality of alignment marks arranged at a pitch corresponding to a pitch of the plurality of alignment patterns.

20. The template according to claim 19, wherein the alignment patterns are formed in an end portion region of the mesa portion between the main pattern and the alignment marks.
